(19) United States
(12) Patent Application Publication
(10) Pub. No.: US 2004/0119972 A1
(43) Pub. Date: Jun. 24, 2004

(54) Identification method

(75) Inventors: Irene Erica Smit-Kingma, Vlaardingen (NL); Ewoud Van Velzen, Vlaardingen (NL); Marinus Maria Warmoeskerken, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/734,026

(22) Filed: Dec. 11, 2003

(30) Foreign Application Priority Data
Dec. 11, 2002 (EP) 02080330.0

(51) Int. Cl. G01N 21/88

(52) U.S. Cl. 356/238.1

(57) ABSTRACT

A method for identifying a textile parameter from a soiled textile article.

This invention relates to an identification method, and in particular to a method for the identification of parameters of a soiled textile article in need of treatment and an apparatus therefor.

Textile articles need to be treated from time to time. Soiled articles need to be cleaned. Some articles only need some conditioning such as softening or refreshing. After aqueous cleaning the articles need to be dried. To choose an optimal treatment such as cleaning, conditioning, drying textile articles the exact nature of the article should be known. For example parameters of a textile article such as the fibre type, dye type, colour and stain type can be critical in selecting the exact treatment regimen. Although the fibre type is often stated on the label and the colour is easily discernible, the other parameters are not always known such as dye type and stain type. Although information about the fibre type and colour is important it often is not enough. White cotton can be treated at high temperatures, e.g. cleaned, dried or even ironed. But in case of dyed cotton, dyes may differ in bleach sensitivity. Each dye type, sometimes combined with a particular fibre type, has its own colour fastness characteristics and bleach sensitivity. Often the type of stain cannot be determined easily. It will be obvious that correct identification of the stain type will help in choosing the correct treatment for an optimal stain removal. Thus since consumers lack a method to simply determine these parameters often the wrong treatment is chosen with undesirable results such as incomplete removal of a stain, colour damage, or even fibre damage. Therefore, there is a need for a simple method for the determination of textile parameters of a soiled textile article in need of treatment.

US 2001/0042391 discloses a laundry washing machine which should comprise a detector for detecting the type of laundry items and for mechanically producing a suggestion for a laundry treatment programme. The detector is preferably said to be a spectrometer. However, this disclosure would seem to be non enabling since it does not teach the skilled person how the type of dye or stain is detected.

US2001/0049846 discloses an optimised laundry washing machine with sensors to sense the characteristics of soiled laundry. The disclosed sensors include, pH sensors, conductivity sensors, water hardness sensors, turbidity sensors, temperature sensors, calcium ion sensors and oxidation-reduction potential sensors.

It is desirable to provide a method for identifying textile parameters such as the stain type that is accurate and so simple that is can be used by any consumer without special skills. The method and the apparatus should be cost-effective. For use in domestic situations, it is important that the method has a short response time, i.e., the textile parameter should be identified in less than eight seconds.

We have now surprisingly found method for the identification of a textile parameter from a soiled textile article in need of treatment, characterised in that the method comprises:

illuminating the surface of a soiled textile article with electromagnetic radiation comprising a spectral range suitable to create sample spectral data for subsequent comparison

collecting sample spectral data from the surface of the textile article, and

identifying the textile parameter by comparing said sample set of spectral data to reference spectral data obtained from reference textile material.

whereby said sample set of spectral data comprises a spectral range with a width of at least 400 nm and the spectral range comprises the wavelength range of from 783 nm to 1183 nm.

According to another aspect of the invention a method of treating a soiled textile article is provided comprising the steps of

identifying a textile parameter of said textile article according to any one of the preceding claims and

choosing a treatment parameter based on the parameter identified in the previous step.

treating the laundry article with a treatment regimen comprising the treatment parameter chosen in the previous step.

According to yet another aspect of the invention an apparatus for the identification of a textile parameter from a soiled textile article is provided comprising: (a) source means for illuminating the surface of a soiled textile article with electromagnetic radiation comprising a spectral range suitable to create spectral data comprising the wavelength range of from 783 nm to 1183 nm for subsequent comparison; (b) photo-detector means for collecting sample spectral data from the surface of the textile article in less than 8 seconds; (c) computer means for identifying the textile parameter by comparing said sample set of spectral data to reference spectral data obtained from reference textile material.

Surprisingly, the present invention provides a simple and accurate method and apparatus to identify textile parameters such as the stain type and dye type, often in one simple reading. The apparatus is cost-effective since it can be easily assembled with off-the-shelf components into a hand held probe. The method and apparatus can be used to quickly identify—say within 8 seconds—said parameter or parameters by holding said probe close to the article, perhaps some millimetres over the textile and/or stain. Furthermore, the present invention also provides a method of treating a textile article wherein the identified textile parameter is used to choose a treatment parameter for an optimal treatment.

These and other aspects, features and advantages will become apparent to those of ordinary skill in the art from a reading of the following detailed description and the appended claims. For the avoidance of doubt, any feature of one aspect of the present invention may be utilised in any other aspect of the invention. It is noted that the examples given in the description below are intended to clarify the invention and are not intended to limit the invention to those examples per se. Unless otherwise indicated, all numbers expressing wavelengths used herein are to be understood as modified in all instances by the term “about”. Numerical ranges expressed in the format “from x to y” are understood to include x and y. When for a specific feature multiple preferred ranges are described in the format “from x to y”, it is understood that all ranges combining the different endpoints are also contemplated. Where the term “comprising” is used in the specification or claims, it is not intended to exclude any terms, steps or features not specifically recited. All temperatures are in degrees Celsius (° C.) unless otherwise specified. All measurements are made at atmospheric pressure and 20° C. and are in SI units unless otherwise specified. All documents cited are in relevant part, incorporated herein by reference. Unless specifically defined otherwise, all technical or scientific terms used herein have the same meaning as commonly understood by one of the ordinary skill in the art to which this invention pertains. Although any methods and materials similar or equivalent to those described herein can be used in the practice of the present invention, the preferred methods and materials are now described.

### DETAILED DESCRIPTION OF THE INVENTION

Spectral data, for purpose of the present invention, are the particular spectra or segments of spectra, often described as the relationship of optical wavelength, frequency, or the like (x-axis) and reflectance, light intensity, absorbance, Kubelka-Munk or the like (y-axis), corresponding to a particular spectrophotometric analysis.

The term “textile article” as used herein is typically a garment but may include any textile article such carpets, rugs upholstery, curtains, linen. Textile articles include—but are not limited to—those made from natural fibres such as cotton, wool, linen, hemp, silk and man made fibres such as nylon, viscose, acetate, polyester, polyamide, polypropylene elastomer, natural or synthetic leather, natural or synthetic fur and mixtures thereof.

The “textile parameter” of the textile article that may be identified according to the first aspect of the present invention includes—but is not limited to—at least one of the group consisting of stain type, dye type, and mixtures thereof. Other parameters may also be identified as long as the parameter is useful to choose a treatment parameter such as colour and fibre type.

The term “treatment parameter” as used herein is intended to mean any parameter used to optimise a treatment to obtain an optimal treatment result. The treatment parameter comprises at least one of the group selected from the treatment type, amount and type of treatment agent, treatment temperature and treatment period.

The textile article in need of treatment may be soiled, wrinkled or just need refreshing. The treatment type may be any treatment suitable for cleaning, conditioning, drying, or otherwise enhancing the appearance, function or condition of the textile article. The treatment type includes but is not limited cleaning, conditioning, drying, and mixtures thereof. Cleaning may be a pretreatment such as prespotting a stain with a pretreatment composition. Cleaning includes the aqueous wash processes but also dry cleaning processes. Conditioning may include any treatment not principally intended for cleaning such as softening or refreshing. Treatments include those disclosed in US 2001/0042391 and US2001/0049846.

In one preferred embodiment a method of treating a textile article is provided according to claim 11. Preferably, the treatment comprises a method of cleaning laundry whereby a treatment parameter comprises at least one of the group selected from the treatment type, amount and type of treatment agent, treatment temperature and treatment period.

Preferably the treatment agent is selected from water, dry cleaning solvent, surfactants, builders, enzymes, bleach activators, bleach catalysts, bleach boosters, bleaches, alkalinity sources, antibacterial agents, colorants, perfumes, pro-perfumes, finishing aids, lime soap dispersants, composition malodour control agents, odour neutralisers, polymeric dye transfer inhibiting agents, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilisers, corrosion inhibitors, diamines or polyamines and/or their alkoxylates, suds stabilising polymers, process aids, fabric softening agents, optical brighteners, hydrotropes, suds or foam suppressors, suds or foam boosters, fabric softeners, anti-static agents, dye fixatives, dye abrasion inhibitors, anti-crocking agents, wrinkle reduction agents, wrinkle resistance agents, soil repellency agents, sunscreen agents, anti-fade agents, and mixtures thereof.

In one preferred embodiment the textile parameter is the stain type and the reference spectral data comprises at least one set of spectral data representing stain types selected from proteinacious, lipid, bleachable, particulate soil and starch stains. When the treatment is a cleaning method, this information enables to choose e.g. the optimal amounts of protease, lipase, bleach, anti redeposition polymer, and amylase respectively.

In another preferred embodiment a textile parameter to be identified is the dye type and the reference spectral data comprises at least one set of spectral data representing dye types selected from direct dyes, vat dyes, reactive dyes, acid dyes, basic dyes, pigment dyes, metal complex dyes, mordants, disperse dyes, sulphur dyes and mixtures thereof. Each dye type, sometimes combined with a particular fibre type, has its own colour fastness characteristics and bleach sensitivity. Thus, the identification of the dye type enables to choose the optimal treatment parameter to avoid colour damage by for example decreasing the amount and/or type of bleach.

Unexpectedly, it was found that according a particularly advantageous embodiment, a textile parameter to be identified in addition to the stain type and/or dye type is the fibre type and the reference spectral data comprises at least one set of spectral data representing fibre types selected from natural fibres and man made fibres cotton and mixtures thereof, preferably the fibres are selected from wool, silk, cotton, hemp, polyester, nylon, lycra, polyamide, viscose, elastan, viocel, leather and mixtures thereof. When the treatment is e.g. a cleaning or drying method, this information enables to choose the optimal temperature for these treatments. In another embodiment, when the treatment involves contacting the textile article with a hydrophobic perfume, the amount of perfume may be optimised when the textile article contains hydrophobic fibres such as polyester.

In yet another preferred embodiment the textile parameter to be identified in addition to the stain type and/or dye type is the colour and the reference spectral data comprises at least one set of spectral data representing colour selected from white, red, pink, yellow, orange, blue, green, purple, brown, black and mixtures thereof. This information may help to choose the right temperature when the treatment is a cleaning method because many coloured articles can only be safely cleaned below 60° C. In another embodiment, this information may be used to select the wash load by excluding the proverbial red sock in an otherwise white wash load. In yet another example the identification of the colour may be used to optimise the amount of anti dye transfer agent in a cleaning process.

A particular advantage of the present method is that it is suitable for the simultaneous identification of at least two textile parameters. For this purpose simultaneous is intended to mean that the spectral data need only collected from the sample one single time to identify at least two textile parameters. Thus, in a preferable embodiment, the method is a method whereby at least two, preferably at least three textile parameters are identified simultaneously. The parameters comprise the stain type and one or more textile parameters selected from dye type, fibre type, colour type. Preferably, the method is a method whereby at least the stain type, colour and fibre type are identified simultaneously.

With regard to the step of illuminating the surface of the textile article, In a preferred embodiment, the surface of a textile article is illuminated with electromagnetic radiation comprising a spectral range suitable to create sample spectral data for the subsequent comparison, in particular a spectral range with a width of at least 400 nm.

As for the step of collecting a sample set of reflectance spectral data from the surface of the textile article, this is preferably carried out by a reflectant spectrometric method to generate a sample set of reflectance spectral data. The spectral data used in the present invention—either from the reference textile material or the textile article to be analysed may be derived from different spectral ranges and are preferably reflectance spectral data. The optical features of the visible near infrared (VIS-NIR) range are particularly suited. The optical features of the VIS-NIR range are generally combinations and overtones of vibrational modes found in the infrared region (2,500 nm to about 25,000 nm). Generally, asymmetric bonds having dipole moments create detectable and distinguishable features in the infrared region. In particular, combinations and overtones associated with the fundamental infrared absorbance associated with the bonds H—X, where H is hydrogen and X is carbon, nitrogen, or oxygen, give particularly intense features. Overtone bands of the H—O, H—C stretching mode and overtones of combination bands of H—O and C—H stretching and bending modes are found in the region between 783 nm and 1672 nm.

Generally, any overtone band, combination band, or combination of overtone and combination bands can be utilised; however, a particular range is generally preferred depending on the system under analysis. For example, for the present invention, spectral data comprising at least the wavelength range of from about of from 783 nm to 1183 nm is very useful. The wavelength range of from 369 to 1183 nm is even more useful. The wavelength range of from 369 to 1672 nm is particularly useful.

With regard to the step of comparing said sample set of spectral data to reference spectral data obtained from reference textile material, this step is preferably carried out using spectral correlations.

The spectral correlations developed for use in the embodiments in accordance with the present invention are generally built utilising most or much of the spectrum of the sample although suitable correlations can also be developed using the reflection measured at a few select wavelengths. Although a spectrum can consist of several hundred intensities measured at different wavelengths, many of these data points are highly interdependent, or colinear. Multivariate Data Analysis (MVDA) techniques can be used to simplify the spectrum into latent variables or factors which describe the independent variations in the spectra for a set of samples. The scores or relative magnitudes of the factors in the spectrum change as the properties of the sample change. The number of factors necessary to accurately model a textile parameter generally depends on the parameter being analysed. Generally, the properties can be modelled using less than or equal 15 factors, frequently less than 10 factors, and sometimes even 5 factors. The number of factors minimally necessary to predict textile properties can be estimated using plots of explained variance using successive numbers of factors, or other forms of statistical analysis.

Preferably, the comparison of said sample set of spectral data to reference spectral data obtained from reference textile material is carried out by means of a calibration model.

This calibration model uses categorised sets spectral data of reference textile material with known textile parameters, which can then be used to identify the textile parameters of an unknown textile article of interest. The spectral data derived from the reference textile material with known textile parameters are preferably input into a computer for use in a calibration model, which preferably uses multivariate data analysis techniques to identify the textile parameter of an unknown textile article of interest. Detailed examples generally relating to the development of a calibration model using multivariate analysis are described in U.S. Pat. Nos. 5,965,888; 5,638,284; 5,680,320; and 5,680,321,the disclosures of which are incorporated herein by reference.

Multivariate analysis is preferably selected from Principal Component Analysis (PCA), Discriminant Analysis (DA), Partial Least Squares Regression (PLS), Principal Component Regression (PCR), and Multilinear Regression Analysis (MLR) and preferably a combination of Principal Component Analysis (PCA) and Discriminant Analysis (DA).

Data Analysis

Principal Component Analysis (PCA) and Discriminant Analysis (DA) are Multivariate Data Analysis (MVDA) techniques that allow the calibration models to be developed. The Mahalanobis Distance (MD) technique is a method that measures the spectral similarity of an unknown sample to multiple groups within a calibration model. When the spectrum of the unknown sample is identified against the groups, the sample is classified as the closest match (or no match at all).

Principal Component Analysis (PCA)

PCA is a procedure for decomposing a multidimensional data set in mathematical spectra (Principal Components) and a set of scaling coefficients (scores) for each Principal Component. These new variables are linear combinations of the original variables. PCA is a standard method for reducing the dimensionality of data. The PCA routine finds the eigenvalues and eigenvectors of the variance-covariance matrix or the correlation matrix. The eigenvalues, giving a measure of the variance accounted for by the corresponding eigenvectors (components), are displayed together with the percentages of variance accounted for by each of these components. PCA is further explained in Wold, S. et al, “Principal Component Analysis”, Chemometr. Intell. Lab., 1-3, 2 (1987), Geladi, P. et al, “Principal Component Analysis of Multivariate Images”, Chemometr. Intell. Lab., 3, 5 (1989) and Brown, S. D., “Chemometrics”, Anal. Chem. 62, 84R-1 0R (1990).

Discriminant Analysis (DA)

This is a method whereby, by use of spectral data, corresponding reference samples are classified into well-defined clusters or categories. From its spectrum, a sample with unknown textile parameters such as stain type and dye type can then be matched to a cluster, and the distance from the cluster-mean can be assigned the best matching identity. A useful discriminant algorithm is one that can “learn” what the spectrum of a sample looks like by “training” it with spectra of the same material. This technique requires a relatively large database to obtain statistically significant results. DA is further explained in Brown, S. D., “Chemometics”, Anal. Chem. 62, 84R-1 0R (1990), Mark, H. L., “Normalized distances for qualitative near-infrared reflectance analysis”, Anal. Chem., 59, 2, 379-384 (1986).

The Mahalanobis Distance (MD)

The Mahalanobis distance (MD) is a generalised distance, which can be considered a single measure of the degree of divergence in the mean values of the different characteristics of the stained- and unstained textile fibres by considering the correlations between the variables. The Mahalanobis distance is a very useful way of determining the similarity of an unknown sample against a collection of known samples. This method has been applied successfully for spectral discrimination in a number of cases. One of the main reasons for using MD is that it is very sensitive to inter-variable changes in the reference data. MD is superior to other multidimensional distances, such as Euclidean distance, because it takes distribution of the points (correlations) into account. MD is further explained in Mahalanobis, P. C., “On the Generalised Distance in Statistics”, Proc. Natl. Inst. of Science of India, 2, 49 (1936).

Preferably, the comparison of said sample set of spectral data to reference spectral data obtained from reference textile material is carried out with a calibration model

A calibration model may comprise training sets which preferably consist of a large number of reflectance spectral data from samples with known identity (reference textile material) that preferably should be representative for the whole range of textile parameters that need to be determined. The training sets are used in the multivariate algorithms to calculate the resulting model parameters.

When Principal Component Analysis, Discriminant Analysis and Mahalanobis Distance are used, a calibration model may be constructed by a method comprising the steps of

(I.a) collecting a background spectrum of poly tetra fluoro ethylene (PTFE). PTFE is a suitable reference material because it reflects most wavelengths in the spectral range 369-1672 nm up to 99%;

(I.b) collecting spectral data of reference textile material, preferably of unstained reference textile material and/or stained reference textile material;

(1.c) rationing the spectral data of reference textile material against the background spectrum to create an absorbance spectrum or a Kubelka-Munk spectrum;

(1.d) applying data pre-processing techniques including baseline correction, normalisation, smoothing, spectral segmentation, light scattering correction, detrending, and/or the conversion to derivative spectra;

(I.e) grouping the spectral data of the reference textile material with corresponding textile parameters such as dye type, stain type, fibre type and colour into separate training sets;

(I.f) decomposing the training set spectra into mathematical spectra (Principal Components) which represent the most common variations to all the data e.g. by performing Principal Component Analysis;

(I.g) calculating a set of scaling coefficients (scores) e.g. for each Principal Component for every reference data in the training sets and use the scores for the Mahalanobis group matrix calculations.

In this case the identification of the textile parameter may include the steps of

(II.a) calculating a set of scaling coefficients (scores) for each Principal Component for every collected sample spectral data;

(II.b) using the scores calculated in the previous step to measure the spectral similarity to each of the training sets by calculating the Mahalanobis Distance's;

(II.c) identifying the textile parameter of the sample against the multiple groups of training samples based on the closest match (or no match at all).

A data output set may, but need not be included in the method of the invention. When used, data output may be according to any means well known, such as a computer display (LCD, TFT, a cathode-ray tube), recording instrument, or signal means such as a diode, lamp, or current.

Textile Parameter Identifier

Measurements can be performed by use of a low-cost, lightweight spectrometer in combination with an on-line, in-line or at-line optical fibre device, or by taking individual samples for separate analysis. Rapid acquisition times with a maximum of 8 seconds are feasible due to use of diode-array detectors. In any case, the spectra may be subject to further data treatment to reduce noise and variability between spectra. It is to be understood that the radiation used in the spectrometric method impinges directly on surface of the textile article.

In a spectrometer, the light is converted into an electric signal which consists of light intensity versus wavelength that is then conveyed to a computer, where the spectra of a previously stored reference textile articles can be compared to the sample spectral data by means of Multivariate Data Analysis techniques. These chemometrical methods are well known in the art, such as the description set forth in U.S. Pat. No. 5,638,284, the disclosure of which is incorporated herein by reference. In this invention, preferably, a spectrometer having a usable wavelength is the range of 369 to 1672 nm is used. However, a scanning instrument, a diode array instrument, a Fourier transform instrument, a monochromator instrument or any other similar equipment known in the art, may be used in accordance with the present invention.

An evaluation of spectral data, which contains absorption, Kubelka-Munk or reflectance data, provides the relevant features for the analysis. By the application of chemometrical methods to the obtained spectra it is possible to ignore wavelengths which do not contain information that contribute to the chemical analysis, even though the measurement will include information from the entire wavelength range.

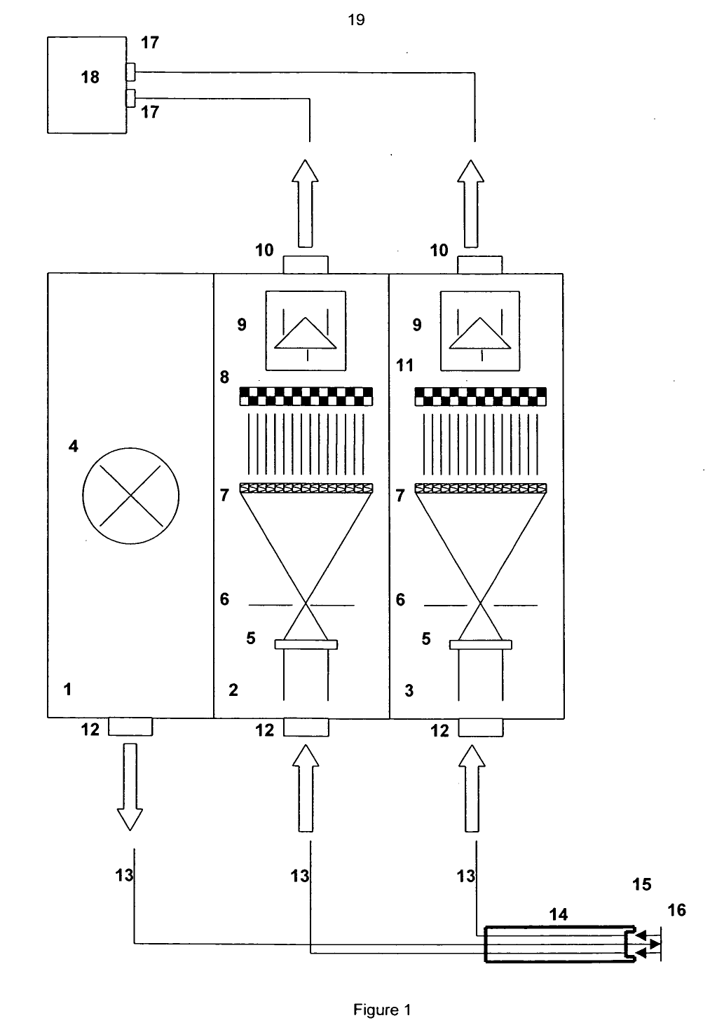

By way of non-limiting example, FIG. 1 shows an apparatus for the identification of a textile parameter from a textile article according to claim 15. The apparatus comprises a source means for illuminating the surface of a textile article with electromagnetic radiation comprising a spectral range suitable to create spectral data for subsequent comparison in lamp module (1) fitted with a Tungsten halogen source (4). The source of the illumination can be a common quartz-envelope tungsten-halogen incandescent light, or similar source that delivers a broad spectrum of energy in the range defined above. The spectral range emitted from the Tungsten lamp is guided through fibre optics (13) to a hand held probe (14) which can be held near the surface (16) of a textile article. The fibre optics between the hand held probe (14) and lamp module (1), visible diode-array module (2) and a near infrared diode-array module (3) are connected to the respective modules via SMA connectors (12). The light (15) reflected from the surface is guided via fibre optics in the handheld probe (14) to a visible diode-array module (2) and a near infrared diode-array module (3). The sample reflectance spectral data travels through lens (5), slit (6) and holographic transmission grating (7) and separated into monochromatic energy before they are collected by a silicon diode-array detector (369 to 783 nm, 256 pixels) (8) and InGaAs diode-array detector (783-1672 nm, 256 pixels) (11), respectively.

A diode array detector is an extremely sensitive and rapid detector, typically consisting of 64, 128, 256 or 1024 photodiodes each connected parallel to a capacitor. Charges, produced by light hitting a diode (photons) are stored in the capacitors. The detector converts the charges to a corresponding voltage between 0 and +10 Volts, which can be read out in a serial way.

If the photons have been monochromatised, the detector provides a spectrum with useful information on the color characteristics and the chemical composition of numerous materials including textile parameters described above.

Data from the detectors is communicated through standard RS232 connector (10) and the serial COM port (17) to a computer (18) for identifying the textile parameter by comparing said sample set of spectral data to reference spectral data obtained from reference textile material. Alternatively, other communication means may be used such a direct cable when the detectors and computer (18) are integrated in one housing. Other communication means include a token ring, Ethernet, telephone modem connection, radio or microwave connection, parallel cables, serial cables, telephone lines, universal serial bus “USB®”, Firewire®, fiber optics, infrared “IR”, radio frequency “RF” (WIFI®, Bluetooth®) and the like, or combinations thereof and any other transmission means suitable for communicating the data from the detectors (9) and (11) to the computer (18).

Computer (18) is used to collect data on the intensities and wavelengths of the reflectance spectral data at the detector. This data can be displayed on a suitable display. In computer (18) the data may be converted to a form useful for further data processing, in particular data processing techniques that involve multivariate data analysis as described above. The computer preferably also includes a user interface with a display as mentioned above and a input means such as keyboard, touch screen, mouse or any other means adapted for inputting information. The identified textile parameter may then be communicated to the user through the display.

In one preferred embodiment, the apparatus and/or handheld probe (14) comprises display means for displaying status information. Status information may comprise information signalling that the probe is ready to scan a new textile article, is busy scanning a textile article or is off line or any other information the user may need to operate the apparatus. The display means may be any suitable display such at least one liquid crystal display or light emitting diode and combination thereof. The apparatus and/or handheld probe (14) may comprise inputting means such as a button for input information. Such information may comprise start of the scan of a new textile article, the scan of an article, the end of a scan of an article or any other information the user may need to operate the apparatus. In another embodiment the hand held probe (14) may comprise proximity sensing means for sensing the proximity of a textile article. Then, the apparatus may be automatically start scanning when a textile article is brought within a predefined range of for example 1 or 2 mm. After the scan is completed this may be communicated to the use through the display means so the user can start to scan a new textile article.

In another embodiment (not shown), the hand held probe (14) may be connected wirelessly to one or more of the modules 1-3. Using standard miniaturisation, modules (1-3) and computer (18) may be designed such that all fit in hand held probe (14) which can be conveniently held in one hand during use and communication to a separate treatment device may be wireless. Computer (18) may also be separate and for example part of a separate treatment device which also calculates the optimal treatment.

In a particularly preferred embodiment when the treatment is a method of cleaning, the method comprises the steps of identifying textile parameters of a complete wash load according to an aspect of the invention, using the identified textile parameters to optimise the treatment parameters. With the term optimise is meant that the treatment result is better than without knowing the identified textile parameter.

In one preferred embodiment, the identified textile parameter is used by a system to create and optimised treatment programme for treating a textile article or a combination of textile articles—of which a textile parameter has been identified. Such systems are disclosed in U.S. Pat. No. 5,644,936, U.S. Pat. No. 5,715,555, and in particular US2001/0042391 and US2001/0049846. Computer (18) may then be separate or part of such a system.

Although, the present invention is especially useful in domestic households it can be used advantageously in many environments, such as commercial and industrial cleaning.

1. A method for the identification of a textile parameter from a soiled textile article in need of treatment, characterised in that the method comprises:
illuminating the surface of a soiled textile article with electromagnetic radiation comprising a spectral range suitable to create sample spectral data for subsequent comparison
collecting sample spectral data from the surface of the textile article, and
identifying the textile parameter by comparing said sample set of spectral data to reference spectral data obtained from reference textile material.
whereby said sample set of spectral data comprises a spectral range with a width of at least 400 nm and the spectral range comprises the wavelength range of from 783 nm to 1183 nm.

2. A method according to claim 1 wherein the spectral band comprises the wavelength range of from 369 to 1183 nm.

3. A method according to claim 1 wherein the spectral band comprises the wavelength range of from 369 to 1672 nm.

4. A method according to claim 1 wherein the comparison is by means of a calibration model using multivariate analysis.

5. A method according to claim 4 wherein said multivariate analysis is selected from Principal Component Analysis (PCA), Discriminant Analysis (DA), Partial Least Squares Regression (PLS), Principal Component Regression (PCR), and Multilinear Regression Analysis (MLR) and preferably a combination of Principal Component Analysis (PCA) and Discriminant Analysis (DA).

6. A method according to claim 1 wherein the textile parameter comprises at least one of the group consisting of stain type, dye type and mixtures thereof.

7. A method according to claim 1 wherein the textile parameter is the stain type and the reference spectral data comprises at least one set of spectral data representing stain types selected from proteinacious, lipid, bleachable, particulate soil and starch stains.

8. A method according to claim 1 wherein the textile parameter is the dye type and the reference spectral data comprises at least one set of spectral data representing dye types selected from direct dyes, vat dyes, reactive dyes, acid dyes, basic dyes, pigment dyes, metal complex dyes, mordants, disperse dyes, sulphur dyes and mixtures thereof.

9. A method according to claim 6 wherein in addition to the stain type and/or dye type, the textile parameter comprises the fibre type and the reference spectral data comprises at least one set of spectral data representing fibre types selected from natural fibres and man made fibres cotton and mixtures thereof, preferably the fibres are selected from wool, silk, cotton, hemp, polyester, nylon, lycra, polyamide, viscose, elastan, viocel, leather and mixtures thereof.

10. A method according to claim 6 wherein in addition to the stain type and/or dye type the textile parameter comprises the colour and the reference spectral data comprises at least one set of spectral data representing colour selected from white, red, pink, yellow, orange, blue, green, purple, brown, black and mixtures thereof.

11. A method of treating a soiled textile article comprising the steps of
identifying a textile parameter of said textile article according to any one of the preceding claims and
choosing a treatment parameter based on the parameter identified in the previous step.
treating the laundry article with a treatment regimen comprising the treatment parameter chosen in the previous step.

12. A method according to claim 11 wherein the treatment parameter comprises at least one of the group selected from the treatment type, amount and type of treatment agent, treatment temperature and treatment period.

13. A method according to claim 12 wherein the treatment type is selected from cleaning, conditioning, drying and mixtures thereof.

14. A method according to claim 12 wherein the treatment agent is selected from water, dry cleaning solvent, surfactants, builders, enzymes, bleach activators, bleach catalysts, bleach boosters, bleaches, alkalinity sources, antibacterial agents, colorants, perfumes, pro-perfumes, finishing aids, lime soap dispersants, composition malodour control agents, odour neutralisers, polymeric dye transfer inhibiting agents, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilisers, corrosion inhibitors, diamines or polyamines and/or their alkoxylates, suds stabilising polymers, process aids, fabric softening agents, optical brighteners, hydrotropes, suds or foam suppressors, suds or foam boosters, anti-static agents, dye fixatives, dye abrasion inhibitors, wrinkle reduction agents, wrinkle resistance agents, soil repellency agents, sunscreen agents, anti-fade agents, and mixtures thereof.

15. An apparatus for the identification of a textile parameter from a soiled textile article comprising: (a) source means for illuminating the surface of a soiled textile article with electromagnetic radiation comprising a spectral range suitable to create spectral data comprising the wavelength range of from 783 nm to 1183 nm for subsequent comparison; (b) photo-detector means for collecting sample spectral data from the surface of the textile article in less than 8 seconds; (c) computer means for identifying the textile parameter by comparing said sample set of spectral data to reference spectral data obtained from reference textile material.
